(19) United States
(12) Patent Application Publication
(10) Pub. No.: US 2007/0070023 A1
(43) Pub. Date: Mar. 29, 2007

(54) Liquid crystal display device

(76) Inventors: Kozo Yasuda, Mobara (JP); Terunori Saitou, Mobara (JP); Teruaki Saito, Mobara (JP); Hideaki Nakatsuka, Mutsuzawa (JP); Toshio Miyazawa, Chiba (JP)

Correspondence Address: Stanley P. Fisher;Reed Smith LLP, Suite 1400, 3110 Fairview Park Drive, Falls Church, VA, 22042-4503, US

(21) Appl. No.: 11/505,482

(22) Filed: Aug. 17, 2006

(30) Foreign Application Priority Data
Sep. 27, 2005 (JP) 2005-279061

(51) Int. Cl. G09G 3/36

(52) U.S. Cl. 345/102

(57) ABSTRACT

To provide a field-sequential liquid crystal display device capable of reducing color shading. The field-sequential liquid crystal display device includes a liquid crystal display panel, a driving circuit driving the liquid crystal display panel and a backlight irradiating plural colors of light including a first color and a second color sequentially, in which a video voltage of one color of the plural colors is written in respective pixels of plural pixels in each field of the one frame period, and light of the one color of the plural colors is emitted from the backlight to display images on the liquid crystal display panel, and when the drive circuit writes a video voltage of the second color next to the video voltage of the first color in a pixel electrode of a first pixel, finish timing of light emission of a light source of the backlight irradiating light of the first color in an area where the first pixel exists is later than start timing of writing the video voltage of the second color in the pixel electrode of the first pixel.

The present application claims priority from Japanese application JP2005-279061 filed on Sep. 27, 2005, the content of which is hereby incorporated by reference into this application.

### BACKGROUND OF THE INVENTION

1. Field of the Invention

The invention relates to a liquid crystal display device, and particularly relates to a drive system of a field-sequential liquid crystal display device.

2. Description of the Related Art

In the field-sequential liquid crystal display device, a color filter is not used for displaying color images, and video signals of red, green, and blue are sequentially written in respective pixels of a liquid crystal panel and a backlight is turned on in accordance with the video signal, switching the color thereof to red, green and blue sequentially to display color images.

Since the field sequential liquid crystal display device does not require a color filter, there is not light absorption by the color filter, further, since it is not necessary to form pixels of red, green and blue on the liquid crystal panel as in a color filter system, a wide pixel aperture area can be taken, as a result, luminance of display images can be improved. Naturally, cost for the color filter can be reduced.

The field sequential liquid crystal display device is described in, for example, Patent document 1, Patent document 2.

As background documents related to the application of the invention, the followings can be cited.

Patent document 1: JP-A-2002-221702

Patent document 2: JP-A-11-295694

### SUMMARY OF THE INVENTION

As described above, in the field-sequential liquid crystal display device, there is not light absorption by the color filter and the wide pixel aperture area can be taken, therefore, luminance of display images can be improved.

However, there are shortcomings such that a drive frequency becomes high because it is required to display images of red, green and blue in one frame, therefore, response speed of the liquid crystal has to be high, or flickers of red, green and blue are seen when a frame frequency is slow.

Particularly, there was a problem that color shading occurs by the response speed of the liquid crystal and lighting timing of a backlight.

The invention has been made for solving the problems of the above related arts, and an advantage of the invention is that a field-sequential liquid crystal display device capable of reducing the color shading can be provided.

The above object, other objects and novel features of the invention will be clarified according to description and attached drawings of the specification.

Typical outlines of inventions disclosed in the application will be described as follows.
(1) A field-sequential liquid crystal display device includes a liquid crystal display panel having plural pixels, a drive circuit driving the liquid crystal display panel and a backlight irradiating plural colors of light including at least a first color and a second color sequentially, in which one frame period is divided into plural fields, a video voltage of one color of the plural colors is written in respective pixels of plural pixels in each field in the one frame period, and light of the one color of the plural colors is emitted from the backlight to display images on the liquid crystal display panel. When the drive circuit writes a video voltage of the second color next to the video voltage of the first color in a pixel electrode of a first pixel as one of the plural pixels, finish timing of light emission of a light source of the backlight irradiating light of the first color in an area where the first pixel exists is later than start timing of writing the video voltage of the second color in the pixel electrode of the first pixel.
(2) In (1), during a period when the drive circuit is writing the video voltage of the first color in the pixel electrode of the first pixel, the backlight does not irradiate the light of the first color in the area where the first pixel exist, and

after the drive circuit has finished writing the video voltage of the first color in the pixel electrode of the first pixel, the backlight irradiates light of the first color in the area where the first pixel exists.
(3) In (1) or (2), the liquid crystal display panel includes a second pixel as one of the plural pixels at a different position from the first pixel, and

the backlight has light-emission timing of the light source when irradiating the light of the first color in the area where the first pixel exists and light-emission timing of the light source when irradiating the first color in the area where the second pixel exists which is different from the former.
(4) In (1) or (2), respective pixels include storage capacities connected to the pixel electrodes of respective pixels, and

after the drive circuit has written video voltages in the storage capacities of respective pixels sequentially, respective video voltages written in the storage capacities of respective pixels are written in the pixel electrodes of respective pixels at a time.
(5) In any of (1) to (4), when a period from the start timing of writing the video voltage of the second color in the pixel electrode of the first pixel until finish timing of light emission of the light source of the backlight irradiating the light of the first color in the area where the first pixel exists is “T”, and one frame period is “M”, the period “T” satisfies T≦M/18.
(6) In any of (1) to (4), when a period from the start timing of writing the video voltage of the second color in the pixel electrode of the first pixel until finish timing of light emission of the light source of the backlight irradiating the light of the first color in the area where the first pixel exists is “T”, the period “T” satisfies T≦1 ms.
(7) In any of (1) to (4), when a period from the start timing of writing video voltage of the second color in the pixel electrode of the first pixel until finish timing of light emission of the light source of the backlight irradiating the light of the first color in the area where the first pixel exists is “T”, the period “T” satisfies 10 μs≦T≦1 ms.
(8) In any of (1) to (4), when a period from the start timing of writing video voltage of the second color in the pixel electrode of the first pixel until finish timing of light emission of the light source of the backlight irradiating the light of the first color in the area where the first pixel exists is “T”, the period “T” satisfies 100 μs≦T≦1 ms.

Advantages obtained by typical inventions disclosed in the application is explained as follows.

According to the field-sequential liquid crystal display device of the invention, it is possible to reduce color shading.

### BRIEF DESCRIPTION OF THE DRAWINGS

FIG. 1 is a block diagram showing a schematic configuration of a liquid crystal display module according to an embodiment 1 of the invention;

FIG. 2 is a circuit diagram showing of an equivalent circuit of an example of a pixel area of a liquid crystal display panel according to the embodiment 1 of the invention;

FIG. 3A to FIG. 3C are timing charts for explaining a driving method of the liquid crystal display module according to the embodiment 1 of the invention;

FIG. 4A to FIG. 4C are timing charts for explaining a driving method of a conventional field-sequential liquid crystal display module;

FIG. 5 is a block diagram showing an example of a lighting control circuit shown in FIG. 1:

FIG. 6 is a block diagram showing a schematic configuration of a liquid crystal display module according to an embodiment 2 of the invention;

FIG. 7 is a timing chart for explaining a driving method of the liquid crystal display module of the embodiment;

FIG. 8 is a timing chart for explaining a driving method of a conventional liquid crystal display module;

FIG. 9 is a circuit diagram showing an equivalent circuit of a pixel area of a liquid crystal display panel according to an embodiment 3 of the invention; and

FIG. 10A to FIG. 10C are timing charts for explaining operations of a liquid crystal display module according to the embodiment 3 of the invention.

### DESCRIPTION OF THE PREFERRED EMBODIMENTS

Hereinafter, embodiments of the invention will be explained in detail with reference to the drawings.

In all drawings for explaining the embodiments, the same numerals and signs are put to components having the same functions, and repeated explanations are omitted.

### Embodiment 1

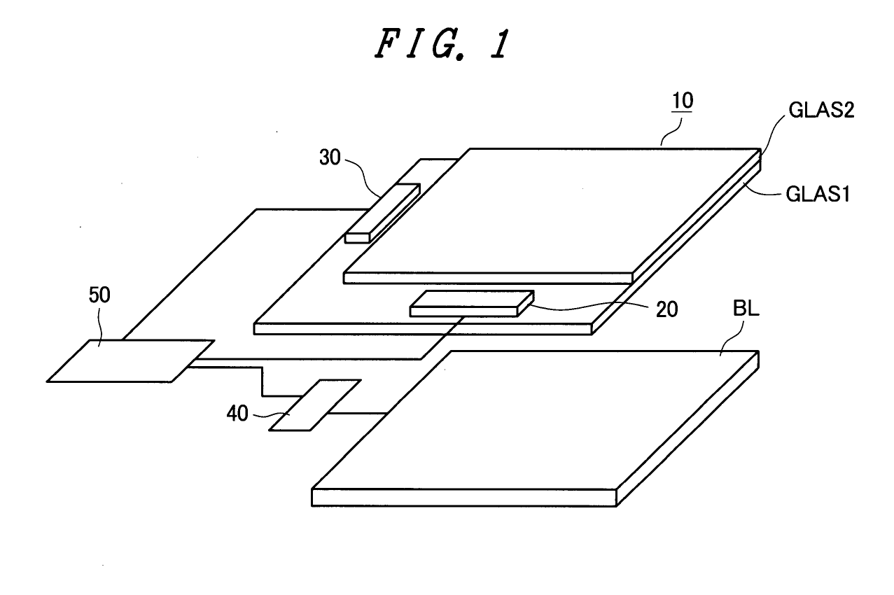

FIG. 1 is a block diagram showing a schematic configuration of a liquid crystal display module according to an embodiment of the invention.

The liquid crystal display module of the invention includes a liquid crystal display panel 10 having plural pixels and a backlight (BL). The liquid crystal display panel 10 has a source driver (sometimes referred to as a drain driver or a video line drive circuit) 20 supplying video voltages to respective pixels and a gate driver (sometimes referred to as a scanning line drive circuit) 30 supplying scanning voltages.

The backlight (BL) is driven by a lighting control circuit 40. The source driver 20, the gate driver 30 and the lighting control circuit 40 are controlled and driven by a timing control circuit 50.

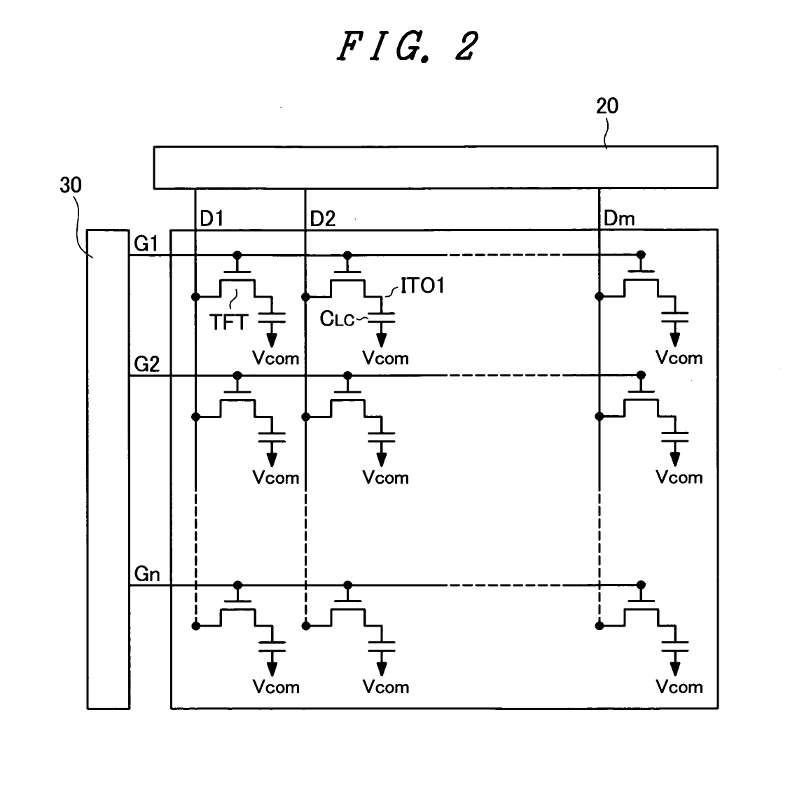

FIG. 2 is a circuit diagram showing an equivalent circuit of an example of a pixel area of the liquid crystal display panel 10 of the embodiment.

In the liquid crystal display panel 10, plural scanning lines (or gate lines) (G1 to Gn) and plural video lines (source lines or drain lines) (D1 to Dm) are provided in parallel respectively. Pixels are provided corresponding to parts where plural scanning lines (G) intersect with plural lines (D).

The plural scanning lines (G1 to Gn) are connected to the gate driver 30 and the plural video lines (D1 to Dm) are connected to the source driver 20.

Plural pixels are arranged in a matrix, a thin-film transistor (TFT) and a pixel electrode (ITO 1) connected to a drain (or a source) of the thin-film transistor (TFT) are provided at each pixel.

A gate of the thin-film transistor (TFT) is connected to a scanning line (G), and the source (or the drain) is connected to a video line (D).

A common electrode (sometimes referred to as a counter electrode) (Vcom) is provided opposite to each pixel electrode (ITO 1), having the liquid crystal therebetween. Therefore, a liquid crystal capacity (CLC) is formed between each pixel electrode (ITO 1) and the common electrode (Vcom).

The liquid crystal display panel 10 is configured such that a glass substrate (GLAS 1) in which the pixel electrode (ITO 1) and the thin-film transistor (TFT) and the like are provided is overlaid on a glass substrate (GLAS 2) in which the common electrode (Vcom) and the like are provided with a predetermined gap therebetween, and both substrates are adhered to each other by a sealant formed into a frame-shape in the vicinity of a periphery between the both substrates, and a liquid crystal is filled inside the sealant between the both substrates from a liquid crystal filling opening provided at a part of the sealant and is sealed, further, polarizing plates are bonded at outer sides of the both substrates.

Since the invention does not relate to an internal configuration of the liquid crystal panel, the detailed explanation of the internal configuration of the liquid crystal panel will be omitted. Further, the invention can be applied to a liquid crystal panel having any configuration.

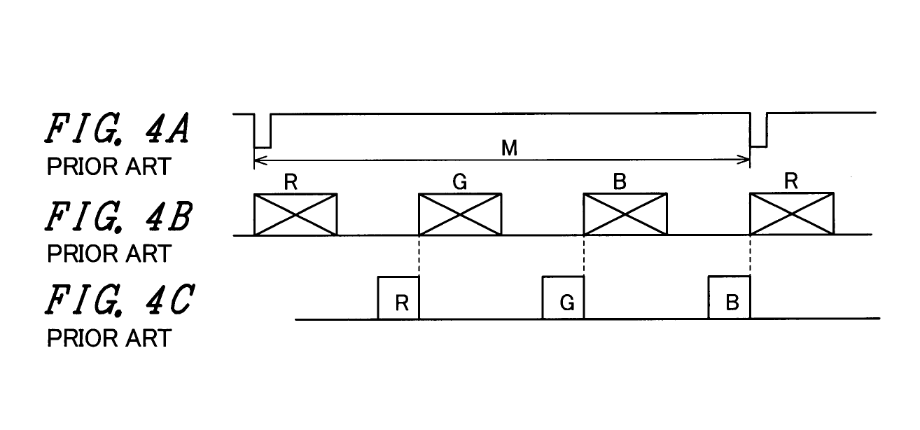

A driving method of a conventional field-sequential liquid crystal display module will be shown in FIG. 4A to FIG. 4C. FIG. 4A shows a frame pulse (also referred to as a frame start signal), FIG. 4B shows writing periods in the liquid crystal display panel 10 according to video voltages of respective colors R, G and B, and FIG. 4C shows lighting timing of the backlight.

As shown in FIG. 4A to FIG. 4C, in the conventional field-sequential liquid crystal display module, one frame period is divided into three fields respectively displaying images of respective colors R, G and B.

In a scanning period of each field, a selected voltage is supplied to respective scanning lines (G) from the gate driver 30, the scanning line (G) is sequentially selected and the thin-film transistor (TFT) is switched on, and a video voltage of each color is supplied to respective video lines (D) from the source driver 20. After video voltages of respective colors R, G and B are written in respective pixels of the liquid crystal display panel 10, the backlight (BL) is turned on, then, color images are displayed on the liquid crystal display panel 10 by irradiating light of the same colors as video voltages written in the liquid crystal display panel 10.

At this time, as shown in FIG. 4C, the backlight (BL) is turned on, after change of the liquid crystal, after writing of video voltages to all pixels of the liquid crystal display panel 10.

If the backlight is turned on during the change of the liquid crystal, the change of the liquid crystal is seen, which leads to the above-mentioned color shading. In the case that start timing of turning on the backlight (BL) is delayed in order to avoid the color shading, a lighting period becomes short and luminance of the liquid crystal display panel 10 decreases.

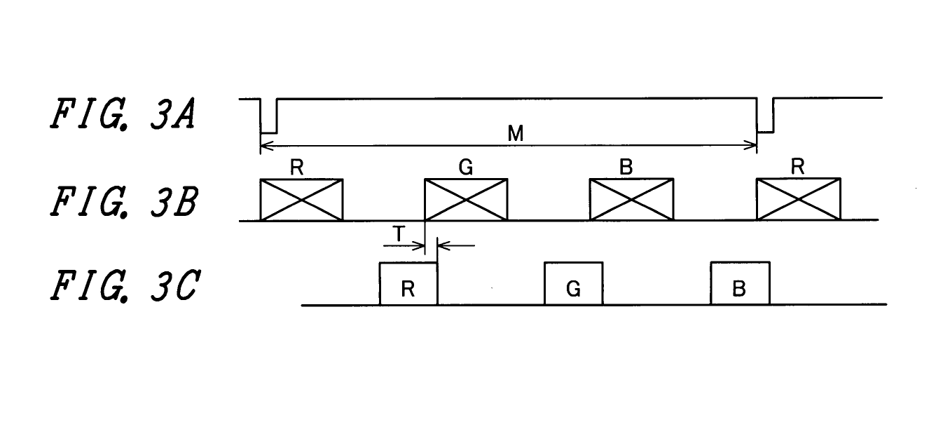

A driving method of a liquid crystal display module according to the embodiment is shown in FIG. 3A to FIG. 3C. FIG. 3A shows a frame pulse (also referred to as a frame start signal), FIG. 3B shows writing periods in the liquid crystal display panel 10 according to video voltages of respective colors R, G and B, and FIG. 3C shows lighting timing of the backlight.

In the embodiment, in order to solve the problem, a lighting period of the backlight (BL) is made to be partially overlapped with a period when a video voltage of a next color is written in pixels of the liquid crystal display panel 10 as shown in FIG. 3C.

Specifically, as shown in FIG. 3C, after the video voltage is written in all pixels of the liquid crystal display panel 10, the backlight (BL) is turned on, after the change of the liquid crystal. Then, after the writing of the video voltages of a next color in pixels of the liquid crystal display panel 10 is started, the lighting of the backlight (BL) is finished.

Accordingly, in the embodiment, finish timing of light emission of the backlight (BL) is later than start timing of writing the video voltage of a next color.

The above is achieved by utilizing a speed characteristic in the change of the liquid crystal and that there is some delay until the time when the change of the liquid crystal starts. That is, the writing periods in FIG. 3B do not coincide with the not-shown changing period of the liquid crystal. Therefore, there is a time gap after the video voltage is written in the pixel electrodes of pixels of the liquid crystal display panel 10 until the liquid crystal changes, and the color shading does not occur during the time gap even if a previous color is lighted.

Accordingly, in the embodiment, a lighting period of the backlight (BL) can be taken longer, as a result, luminance of the panel can be improved.

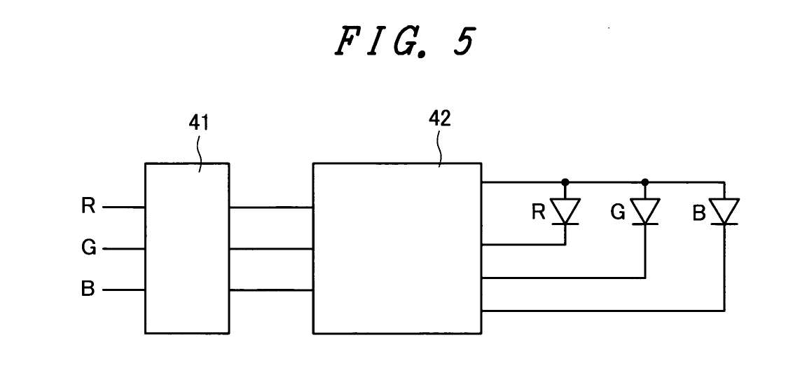

FIG. 5 is a block diagram showing an example of a lighting control circuit 40 shown in FIG. 1.

In a circuit configuration shown in FIG. 5, a backlight pulse inputted from the timing control circuit 50 (a pulse synchronized with display timing of each color) is delayed to a writing period of a next video voltage by a phase adjustment circuit 41.

The backlight pulses which have been delayed in the phase adjustment circuit 41 are inputted to a backlight drive circuit 42 to emit light of red, green and blue. In FIG. 5, an example that respective light emitting diodes of red, green and blue are lighted is shown as light sources.

In the embodiment, as shown in FIG. 3C, when the period from the start timing of writing the video voltage of a next color in the pixel electrodes of pixels of the liquid crystal display panel 10 until the finish timing of light emission of the backlight (BL) is “T” and one frame period is “M”, it is preferable that the period T satisfies T≦M18.

It is also desirable that the period “T” satisfies T≦1 ms, preferably, the period “T” satisfies 10 μs≦T≦1 ms, more preferably, the period “T” satisfies 100 μs≦T≦1 ms.

### Embodiment 2

The embodiment is an embodiment in which the invention is applied to a liquid crystal display module dividing the liquid crystal display 10 into plural areas virtually and displaying images in the field sequential system in each divided area.

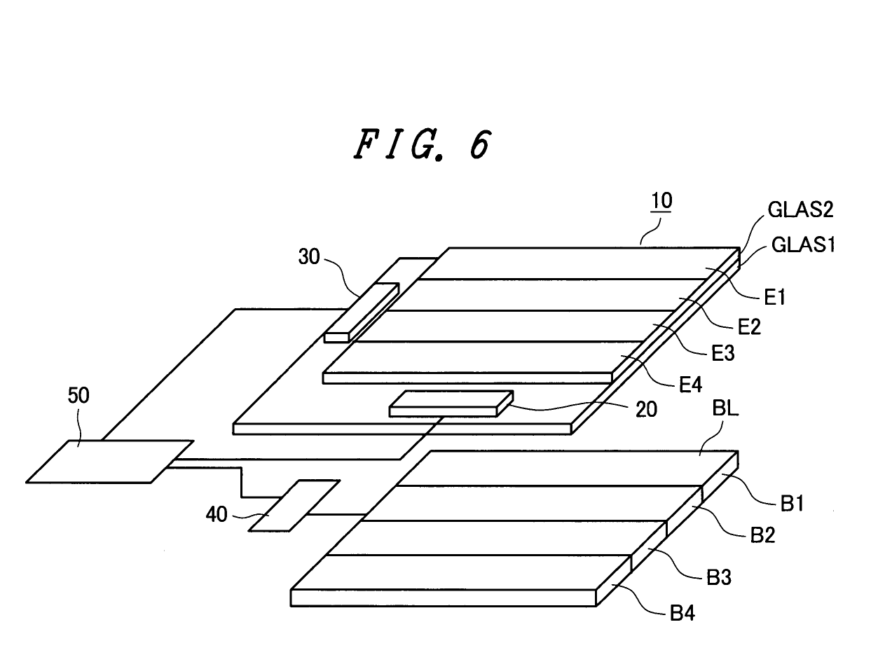

FIG. 6 is a block diagram showing a schematic configuration of a liquid crystal display module according to an embodiment 2 of the invention.

The liquid crystal display module of the invention differs from the liquid crystal display module shown in FIG. 1 in a point that a pixel area of the liquid crystal display panel 10 is divided into four, namely, E1 to E4, and the backlight (B) is also divided into 4, namely, B1 to B4 correspondingly, and the lighting control circuit 40 controls the respective divided backlights (B1 to B4) individually.

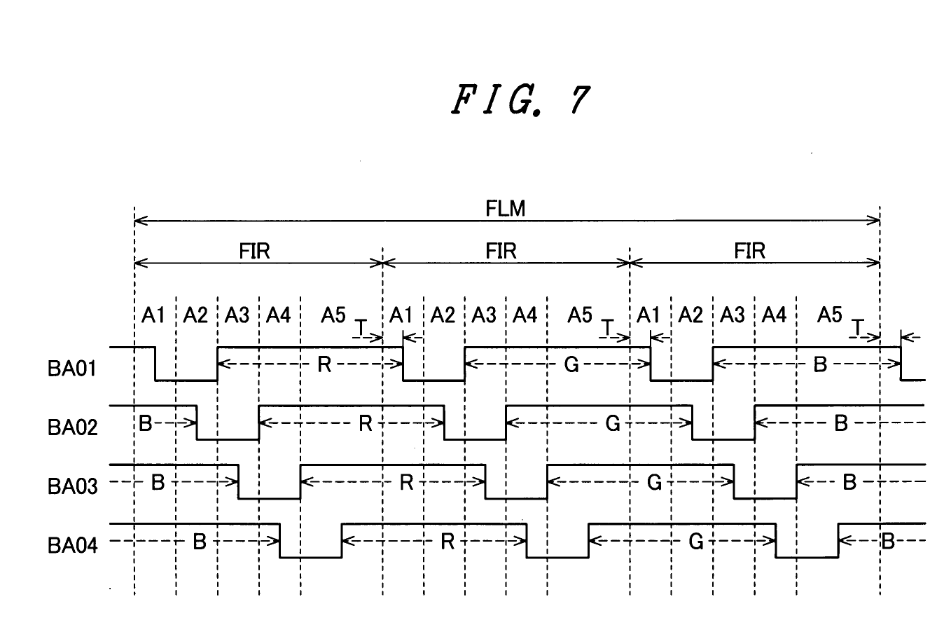

FIG. 7 is a timing chart for explaining a driving method of the liquid crystal display module of the embodiment. In FIG. 7, FLM denotes a frame period, and FIR denotes a field period.

“A1” denotes a writing period of a video voltage with respect to a pixel area (E1) selected by scanning lines (G) from a first line to a “N^{th}” line in the liquid crystal display panel 10, “A2” denotes a writing period of the video voltage with respect to a pixel area (E2) selected by scanning lines (G) from a (N+1)^{th} line to a “2N^{th}” line in the liquid crystal display panel 10, “A3” denotes a writing period of the video voltage with respect to a pixel area (E3) selected by scanning lines (G) from a (2N+1) line to a “3N” line in the liquid crystal display panel 10 and “A4” denotes a writing period of the video voltage with respect to a pixel area (E4) selected by scanning lines (G) from a (3N+1)^{th} line to a “4N^{th}” line in the liquid crystal display panel 10. In this case, the liquid crystal display panel 10 is assumed to have scanning lines (G) from the first line to the “4N^{th}” line. In FIG. 7, “A5” denotes a retrace period.

Furthermore, in FIG. 7, “BA01” to “BA04” denote on-periods and off-periods of the divided backlights (B1 to B4), dashed lines with arrows represent lighting periods, and R, G and B in the dashed lines with arrows respectively represent lighting colors of red, green and blue.

As shown in FIG. 7, after the video voltage is written to pixels of the pixel area (E1) during the period “A1”, the backlight (B1) is turned on at start timing of the period “A3”. Similarly, after video voltages are written also in pixels of the pixel areas (E2 to E4), the backlights (B2 to B4) are turned on, thereby displaying color images in the liquid crystal display panel 10.

Accordingly, the liquid crystal display panel 10 has second pixels at different positions from first pixels, and the backlight (BL) has light-emission timing of a light source when irradiating light of a first color in the area where the first pixels exist and light-emission timing of a light source when irradiating light of the first color in the area where the second pixels exist, which differs from the former.

According to the above configuration, for example, even when the video voltage is written in pixels in the pixel area (E3) or the pixel area (E4), display can be started by lighting the backlight (B1) in the pixels of the pixel area (E1), therefore, there is an advantage that time during which the backlight (B1) is lighted can be maintained long. Also when using a liquid crystal whose response is slow, waiting time for the response to be finished can be secured, therefore, the liquid crystal having slow response can be possible.

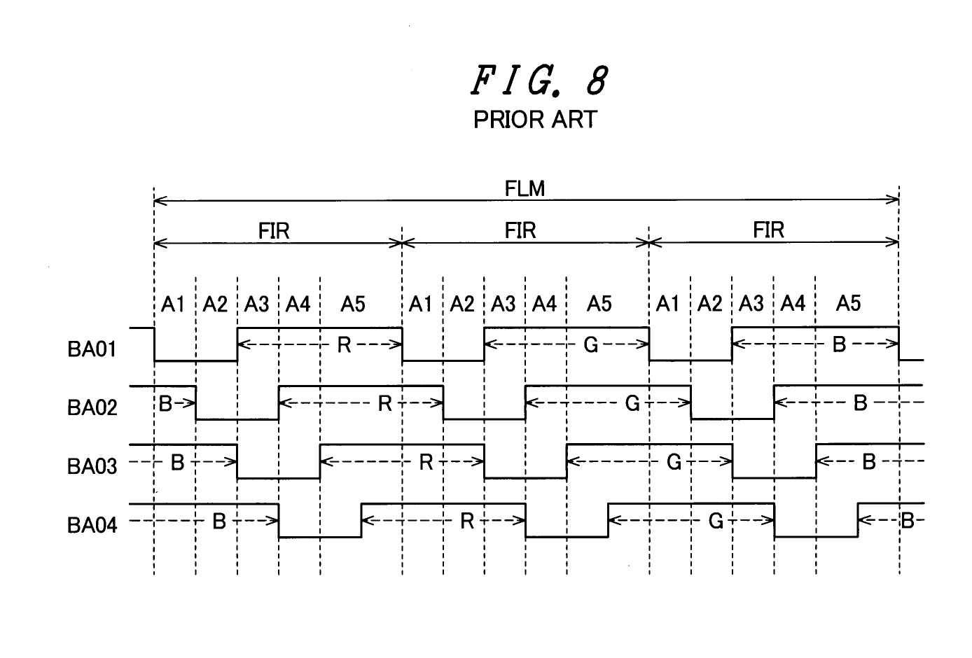

FIG. 8 shows a timing chart for explaining a driving method of a conventional liquid crystal display module.

As seen from comparison with FIG. 8, also in the embodiment, finish timing of light emission of the backlights (B1 to B4) is later than start timing of writing the video voltage of a next color in pixels of the pixel areas (E1 to E4) of the liquid crystal display panel 10.

Also in the embodiment, as shown in FIG. 7, when the period from the start timing of writing the video voltages of a next color in the pixel electrodes of pixels of the pixel areas (E1 to E4) of the liquid crystal display panel 10 until the finish timing of light emission of the backlights (B1 to B4) is “T”, and one frame period is “M”, it is preferable that the period “T” satisfies T≧M/18.

It is also desirable that the period “T” satisfies T≧1 ms, preferably, the period “T” satisfies 10 μs≧T≧1 ms, more preferably, the period “T” satisfies 100 μs≧T≧1 ms.

### Embodiment 3

The embodiment is an embodiment in which the invention is applied to a liquid crystal display module provided with storage capacities (C_{ST}) in pixels of the liquid crystal display panel 10, and transferring a video voltage to the pixel electrodes (ITO1) at the same time after the video voltage is sequentially written in the storage capacities (C_{ST}) to display images in the field-sequential system.

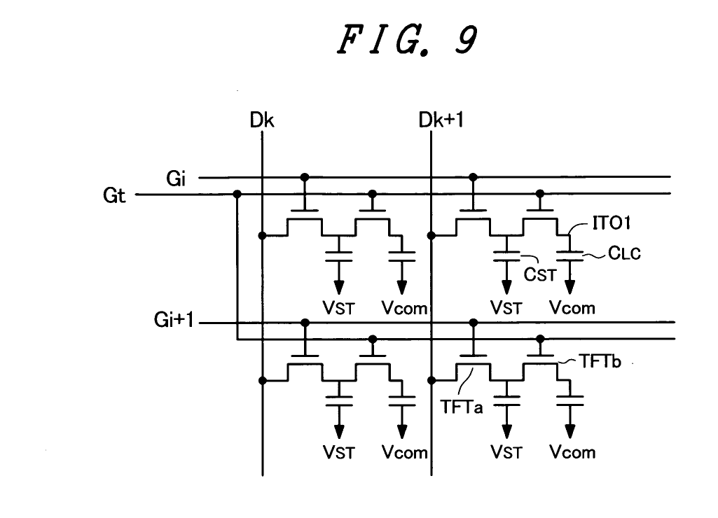

FIG. 9 is a circuit diagram showing an equivalent circuit of pixels of the liquid crystal display panel 10 according to the embodiment.

In the embodiment, each pixel has a first thin-film transistor (TFTa), a second thin-film transistor (TFTb), a storage capacity (Cₛₜ) and a liquid crystal capacity (C_{LC}).

A gate of the first thin-film transistor (TFTa) is connected to a scanning line (G) and a source (or a drain) thereof is connected to a video line (D). The drain (or the source) of the first thin-film transistor (TFTa) is also connected to the storage capacity (Cₛₜ).

A gate of the second thin-film transistor (TFTb) is connected to a batch driving line (Gt) and a source (or a drain) thereof is connected to the storage capacity (Cₛₜ), and the drain (or the source) thereof is connected to a pixel electrode (ITO1) The pixel electrode (ITO1) is connected to the liquid crystal capacity (CLC).

Respective video lines (D) are connected to the source driver 20 and respective scanning lines (G) are connected to the gate driver 30, and further, batch driving lines (Gt) are connected to, for example, the gate driver 30.

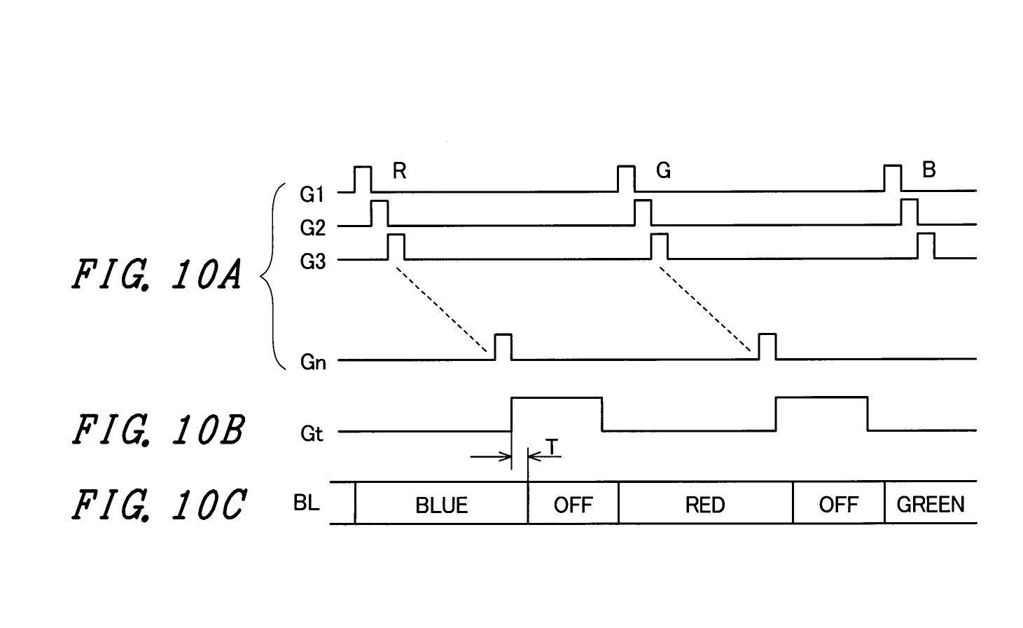

FIG. 10A to FIG. 10C are timing charts for explaining operations of the liquid crystal display module according to the embodiment.

In the embodiment, as shown in FIG. 10A, in a first field, a selected voltage is applied to respective scanning lines (G1 to Gn) from the gate driver 30 and respective scanning lines (G1 to Gn) are sequentially selected to switch on the first thin-film transistors (TFTa), then, a video voltage of red (R) is supplied from a source driver 20 to respective video lines (D) and a video voltage of red (R) is written in the storage capacities (C_{ST}).

After the video voltage is written in the storage capacities (C_{ST}) of all pixels of the liquid crystal display panel 10, as shown in FIG. 10B, a writing pulse is supplied to the batch driving line (Gt) to switch on the second thin-film transistors (TFTb), then, the video voltage of red (R) is transferred from the storage capacities (C_{ST}) to pixel electrodes (ITO1) to write the video voltage of red (R) to pixel electrodes of respective pixels in the liquid crystal display panel 10 at a time.

After that, as shown in FIG. 10C, the backlight (BL) is turned on in red (RED), and color images are displayed on the liquid crystal display panel 10 by irradiating the same color as the video voltage written in the liquid crystal display panel 10. Then, the backlight (BL) is turned off.

The same operation is sequentially performed with respect to green (G) in the next field, then, blue (B) in the further next field. By repeating the operation, color images are displayed.

At this time, there is an advantage that time during which the backlight (BL) is lighted can be secured long because a video voltage of green (G) as a next color can be written in the storage capacities (C_{ST}) during the backlight (BL) is lighted in red (RED). It is possible to use the liquid crystal having slow response speed also according to the embodiment in the same way as the embodiment 2.

In this case, finish timing of light emission of the backlight (BL) is later than start timing of batch writing in which the video voltage of a next color is transferred to pixel electrodes (ITO1) of the liquid crystal display panel 10 at a time.

Also in the embodiment, as shown in FIG. 10C, when a period from start timing of batch writing of the video voltage of a next color in the pixel electrodes of respective pixels of the liquid crystal display panel 10 until finish timing of light emission of the backlight (BL) is “T”, and one frame period is “M”, it is preferable that the period T satisfies T≦M/18.

It is also desirable that the period “T” satisfies T≦1 ms, preferably, the period “T” satisfies 10 μs≦T≦1 ms, more preferably, the period “T” satisfies 100 μs≦T≦1 ms.

The invention made by present inventors have been specifically described based on the embodiments as the above, however, the invention is not limited to the embodiments and can be modified variously within a range not departing from the gist thereof.

What is claimed is:

1. A liquid crystal display device which applies a field sequential system, comprising:
a liquid crystal display panel having plural pixels;
a drive circuit driving the liquid crystal display panel; and
a backlight irradiating plural colors of light including at least a first color and a second color sequentially,
in which one frame period is divided into plural fields, a video voltage of one color of the plural colors is written in respective pixels of plural pixels in each field in the one frame period, and light of the one color of the plural colors is emitted from the backlight to display images on the liquid crystal display panel,
wherein, when the drive circuit writes a video voltage of the second color next to the video voltage of the first color in a pixel electrode of a first pixel as one of the plural pixels, finish timing of light emission of a light source of the backlight irradiating light of the first color in an area where the first pixel exists is later than start timing of writing the video voltage of the second color in the pixel electrode of the first pixel.

2. The liquid crystal display device according to claim 1,
wherein, during a period when the drive circuit is writing the video voltage of the first color in the pixel electrode of the first pixel, the backlight does not irradiate the light of the first color in the area where the first pixel exist, and
after the drive circuit has finished writing the video voltage of the first color in the pixel electrode of the first pixel, the backlight irradiates light of the first color in the area where the first pixel exists.

3. The liquid crystal display device according to claim 1,
wherein the liquid crystal display panel includes a second pixel as one of the plural pixels at a different position from the first pixel, and
the backlight has light-emission timing of the light source when irradiating the light of the first color in the area where the first pixel exists, and light-emission timing of the light source when irradiating the first color in the area where the second pixel exists which is different from the former.

4. The liquid crystal display device according to claim 1,
wherein respective pixels include storage capacities connected to the pixel electrodes of respective pixels, and
after the drive circuit has written video voltages in the storage capacities of respective pixels sequentially, respective video voltages written in the storage capacities of respective pixels are written in the pixel electrodes of respective pixels at a time.

5. The liquid crystal display device according to claim 1,
wherein, when a period from the start timing of writing the video voltage of the second color in the pixel electrode of the first pixel until finish timing of light emission of the light source of the backlight irradiating the light of the first color in the area where the first pixel exists is “T”, and one frame period is “M”, the period “T” satisfies T<M/18.

6. The liquid crystal display device according to claim 1,
wherein, when a period from the start timing of writing the video voltage of the second color in the pixel electrode of the first pixel until finish timing of light emission of the light source of the backlight irradiating the light of the first color in the area where the first pixel exists is “T”, the period “T” satisfies T≦1 ms.

7. The liquid crystal display device according to claim 1,
wherein, when a period from the start timing of writing the video voltage of the second color in the pixel electrode of the first pixel until finish timing of light emission of the light source of the backlight irradiating the light of the first color in the area where the first pixel exists is “T”, the period “T” satisfies 10 μs≦T≦1 ms.

8. The liquid crystal display device according to claim 1,
wherein, when a period from the start timing of writing the video voltage of the second color in the pixel electrode of the first pixel until finish timing of light emission of the light source of the backlight irradiating the light of the first color in the area where the first pixel exists is “T”, the period “T” satisfies 100 μs≦T≦1 ms.
